(19) United States
(12) Patent Application Publication
(10) Pub. No.: US 2006/0176268 A1
(43) Pub. Date: Aug. 10, 2006

(54) Device for inputting control signals to a peripheral unit and a combination including such a device

(75) Inventors: Tomas Oquist, Upplands Vasby (SE); Kurt Hognelid, Bromma (SE)

Correspondence Address: McCormick Paulding & Huber, CityPlace II, 185 Asylum Street, Hartford, CT, 06103-3402, US

(73) Assignee: PARIFIC AB, SUNDBYGERB (SE)

(21) Appl. No.: 10/516,285

(22) PCT Filed: May 23, 2003
(86) PCT No.: PCT/SE03/00844

§ 371 Date: Mar. 15, 2006

(30) Foreign Application Priority Data
May 28, 2002 (SE) 0201580-8

(51) Int. Cl. G09G 5/00

(52) U.S. Cl. 345/156

(57) ABSTRACT

The invention concerns a device for inputting control signals to a peripheral unit. The device is designed to be able to be used in both a first and a second working position. In the first working position it is worn on a first hand of a user. It comprises at least a first input member which functions as a pointer device in said first working position. In the second working position the device is arrangable on a surface and movable across this surface, similar to a standard computer mouse. The device comprises a sensing member (which may or may not be identical with the first input member), which senses the movement of said device in said second working position. The invention also concerns the combination of such a device and a peripheral unit.

### BACKGROUND OF THE INVENTION

The present invention concerns a device for inputting control signals to a peripheral unit. The device is designed to be worn on a first hand of a user of the device such that the device is retainable in at least one predetermined position on said first hand. The device comprises at least a first input member arranged such that the manipulation of this first input member causes the device to produce control signals suited to be transmitted to said peripheral unit such that the manipulation of said first input member fulfils the same function as the manipulation of a joystick or as the movement of a standard computer mouse. Said first input member is arranged on said device such that when the device is retained in said predetermined position on said first hand, the first input member is easily manipulated by one or more fingers of said user.

The invention also concerns the combination of such a device and a peripheral unit.

It should be noted that the “first input member” according to the present invention is arranged to fulfil the same function as a standard computer mouse, a joystick, a track-ball or similar device. The first input member may also be called a pointer device. The first input member may thus be used to move a cursor, an arrow or other computer controlled entity in different directions.

A portable device as described above is known from, for example, U.S. Pat. No. 5,832,296. This document describes a device that is worn as a ring around a finger of a hand of a user. The device may fulfil the same function as a standard computer mouse (see column 7, lines 6-18). The device is designed to be operated by the thumb of the same hand on which the device is worn.

WO 96/39679 describes a portable input device to be worn around a finger of a user. The device may comprise a micro joystick.

FR-A-2 800 187 describes a device which is worn on two fingers of a user. The device comprises a ball which functions as a pointer device.

U.S. Pat. No. 6,154,199 shows a glove-like device which can be worn on a hand. The device comprises a pointer device which can be moved with the thumb of the same hand as on which the device is worn.

A standard computer mouse is of course also known. Such a computer mouse is designed to be moved over a surface. The movement in different directions is detected and transformed into electrical signals used to move, for example, a cursor or pointing arrow on a computer screen.

A standard computer mouse usually comprises a ball which is rotated when the mouse is moved across a surface. The rotation of the ball can be detected by electrical or optical means. It is however also known that a computer mouse can be constructed without using a ball. For example U.S. Pat. No. B1-6,281,882 discloses a computer mouse which optically senses the movement of the mouse across a surface without using a ball.

U.S. Pat. No. 6,075,540 describes a pointer device which detects the movement of a finger by optical means.

The above described input devices have certain disadvantages. The standard computer mouse restricts the user to operate the mouse on a desk or other support surface. The use of such a computer mouse may lead to a static working position which may cause strain on the arm and hand used to operate the mouse. The devices described above, in which the pointer device is worn on a hand, are designed such that the pointer device is operated by the same hand as that on which it is worn. Also these devices may lead to a static working habit.

### SUMMARY OF THE INVENTION

An object of the invention is to provide a device of the kind specified in the first paragraph above but which allows for more flexibility in the way it can be used. A further object is to provide such a device which can be used in different manners depending on the preferences of the user.

The above objects are achieved by a portable device of the kind described in the first paragraph above, wherein the device is designed such that, in addition to the first working position described in the mention paragraph, it is, in a second working position, arrangable on a surface and movable across this surface and comprises a sensing member which senses the movement of said device across said surface and in response hereto causes the device to produce control signals suited to be transmitted to said peripheral unit such that the movement of said device across said surface fulfils the same function as the movement of a standard computer mouse.

It may be noted that by the expression “retainable in at least one predetermined position on said first hand” is meant preferably that the device is designed to be worn on the hand in a predetermined manner and to remain on the hand without the user having to actively grip the device. The user does thus not have to actively hold the device in order for it to stay on the hand. It may also be noted that the first input member should be such that by manipulating this input member a cursor or other entity of the peripheral device should be able to be moved in all different directions on for example a screen. Preferably, the first input member comprises a single input member which can be manipulated in different directions, i.e. not only up and down and to the left and to the right but also into intermediate positions such as for example a normal joystick or a track ball. It should also be noted that although the device is designed to be retainable in one predetermined position on the first hand, it is of course possible that a user can use it also in other positions by for example gripping the device. The device may thus also be designed to be held in a second position. However, the device is always designed such that there is at least one predetermined position in which the device is retained on said first hand, without any necessity for the user to actively grip the device in order to retain it on the hand. The user is of course not compelled to use the device in said one predetermined position.

The device according to the invention thus has the advantage that it can be used both when worn on a hand and also by being movable across a surface. This allows for a greater flexibility in the use. A user who prefers a working position similar to that of a standard computer mouse may use the device in this manner. The device may however also be used worn on the first hand. This allows for more flexibility since the user in this case in not bound to position the device on a surface.

According to one preferred embodiment of the invention, said first input member and said sensing member are one and the same member. The device may according to this embodiment be constructed with fewer components since the same member functions both as the first input member and as the sensing member, i.e. the same member works in both the first and second working position.

According to a preferred embodiment, the mentioned member comprises a ball, wherein the device is arranged to sense the rotation of this ball and to produce said control signals in response to the rotation of this ball. According to another embodiment, said member comprises an optical sensing member, wherein the device is arranged to optically sense the relative movement between an object, such as a finger or a surface, and said device and to produce said control signals in response to the sensed relative movement. Both these embodiments function well both in the first and the second working position.

Preferably, in addition to said first input member, the device comprises at least a second input member. For example the device may comprise at least two additional input members which may function as the click-buttons on a standard computer mouse.

According to one embodiment, the device is arranged to generate a first and second mode control signal indicating, respectively, a first and second operation mode. The first operation mode is intended for the situation when the device is in said first working position and the second operation mode is intended for the situation when the device is in the second working position. In the first operation mode, the manipulation of the first input member in a first direction relative to the device corresponds to the movement of a cursor or other entity of said peripheral unit in a fist corresponding direction. In the second operation mode, the manipulation of said first input member in said first direction relative to the device corresponds to the movement of a cursor or other entity of said peripheral unit in a second direction which is different from said first corresponding direction. The second direction may for example, according to one embodiment, be substantially opposite to said first corresponding direction. This embodiment has the advantage that when the device is used in said second operation mode, the movement of the device generates control signals corresponding to those of a standard computer mouse. When the device is in the first working position, the device may control a cursor in the same manner as for example when operating a track-ball or a joystick. It may be noted that it is not always necessary to arrange the device to have two operation modes. Depending on how the device is gripped in the second working position, and how possible additional input members are located, it may be possible to move the device and to control the cursor or other entity in the same manner as a standard computer mouse without having to set the device in a second operation mode.

The device may be arranged with means for sensing whether the device is in said first or second working position and to automatically generate said first or second mode control signals. Alternatively, the device may be arranged such that a user by manipulating an input member on the device can select said first or second operation mode. Of course, these embodiments may also be combined such that the device normally automatically selects the operation mode, while the user also has the possibility to manually select the operation mode.

According to one embodiment, the device comprises a U-shaped portion, which thus has first and second at least relatively straight parts and a bent part connecting the first and second parts, wherein the device is designed to, in said first working position, when the device is retained in said predetermined position on said first hand, be worn on said first hand such that the first part is located essentially on the back of the hand, the second part is located essentially on the palm side of the hand while the bent part extends from the back of the hand to the palm side of the hand in the region between the thumb and the index finger of said first hand. Such a device is easy to position on the hand. Such a device can also be securely retained to the hand. Furthermore, the device is not in the way when using the fingers for other purposes, such as typing on a computer keyboard.

Preferably, the device is designed such that when it is in said second working position it is able to rest in a stable manner on a substantially flat horizontal surface and to be moved across this surface while maintaining the stable predefined manner. In the second working position, the device thus rests in a stable manner, similar to a standard computer mouse. If the device comprises a U-shaped portion, the stable position may be obtained in different manners by designing the device and positioning the first input member suitably. For example, the U-shaped portion may form a U when observed from above on a horizontal surface. Alternatively, the U-shaped portion may form a U when seen from the side. It should however be mentioned, that according to an alternative embodiment, the device can be designed such that it does not be itself rest in a stable predefined manner in said second working position, but is designed to be supported by the hand in this second working position.

Preferably, the first input member is positioned on the device such that when the device is arranged in the first working position and when the device is retained in said predetermined position on said first hand, the first input member is positioned not on any of the fingers but within an area on said first hand that is substantially either on the back of the hand including the lower portion of the thumb and extending to and including the outer boundary of the thumb or in the region between the thumb and the part of the side of the hand located closest to the thumb, such that the first input member is easily manipulated with one or more fingers of the second hand of the user. The first input member may for example be positioned on the first part or on the bent part in case the device comprises a U-shaped portion. It has been shown that such an arrangement of the first input member makes it easy and comfortable to use the device.

The device preferably comprises a transmitter unit arranged for transmitting the control signals to the peripheral unit in a wireless manner. Although it is also possible to connect the device to the peripheral unit by means of a cable, it allows for more flexibility in the use of the device if the device communicates in a wireless manner with the peripheral unit.

Although it has been described above that the first input member is identical with the sensing member, it is also possible, according to another aspect of the invention, that the first input member and the sensing member are different members. The device thus comprises two such members. Each member may be positioned in an optimal way for being operated in said first and second working positions, respectively.

The first input member may also according to this embodiment for example comprise a ball or an optical sensing member. However, the first input member may also comprise different kinds of input members, such as a joystick or a touch sensitive surface. The sensing member may be of the same kind as the first input member, alternatively the sensing member may be of a different kind. For example, the sensing member may comprise a ball or an optical sensing member.

Also according to this embodiment, in addition to said first input member and said sensing member, the device preferably comprises at least a second input member. The device may of course comprise more input members, for example, for fulfilling the function of the click-buttons on a standard computer mouse. The device may also comprise a scroll-wheel or other input members. The device may also comprise further input members, which makes it possible to input alphanumerical characters to the peripheral unit.

Also according to this aspect, the device can be formed with a U-shaped portion in the manner which has been described above. The general design of the device may thus be in accordance with the above described embodiments.

The device may preferably be arranged for transmitting the control signals to the peripheral unit in a wireless manner. It is also preferably arranged to operate in a first or second operation mode, wherein in the first operation mode the first input member is activated to control a cursor or other entity of said peripheral unit, while in the second operation mode the sensing member is activated to control a cursor or other entity of the peripheral unit. Also in this case, the working position may be automatically sensed and/or the device may be arranged such that a user by manipulating an input member on the device can select whether the device is in said first or second operation mode.

The invention also concerns a combination of the device according to any of the above described embodiments and a peripheral unit. The combination is set up or programmed such that the manipulation of said first input member or the movement of said device across said surface causes the peripheral unit to control at least one entity of the peripheral unit. The peripheral unit may, for example, include a computer and a screen. The combination can be set up or programmed such that the manipulation of said first input member or the movement of said device across said surface causes a cursor or other graphical entity to move across said screen. According to the combination, the device is thus actively connected to a peripheral unit in order to control some entity.

### SHORT DESCRIPTION OF THE DRAWINGS

FIG. 1 schematically shows a perspective view from the side of an embodiment of the device according to the invention.

FIG. 2 shows schematically a front view of an embodiment of the device when the device is in a second working position.

FIG. 3 shows schematically a view of the device in the second working position according to another embodiment.

FIG. 4 shows schematically a side view of the device in the second working position according to another embodiment of the invention.

FIG. 5 shows schematically a side view of the device according to another embodiment of the invention.

FIG. 6 shows schematically the device of FIG. 5 in the second working position.

FIG. 7 shows schematically a side view of another embodiment of the invention.

FIG. 8 shows schematically a front view of the device of FIG. 7 in the second working position.

FIG. 9 shows schematically a side view of another embodiment of the invention.

FIG. 10 shows schematically the device of FIG. 9 in the second working position.

FIG. 11 shows schematically a side view of another embodiment of the device according to the invention.

FIG. 12 shows schematically a front view of the device according to FIG. 11 in the second working position.

FIG. 13 shows schematically the device according to the invention worn on a hand of a user.

FIG. 14 shows schematically a manner of operating an embodiment of the device according to the invention.

FIG. 15 shows schematically a combination according to the invention.

### DESCRIPTION OF EMBODIMENTS OF THE INVENTION

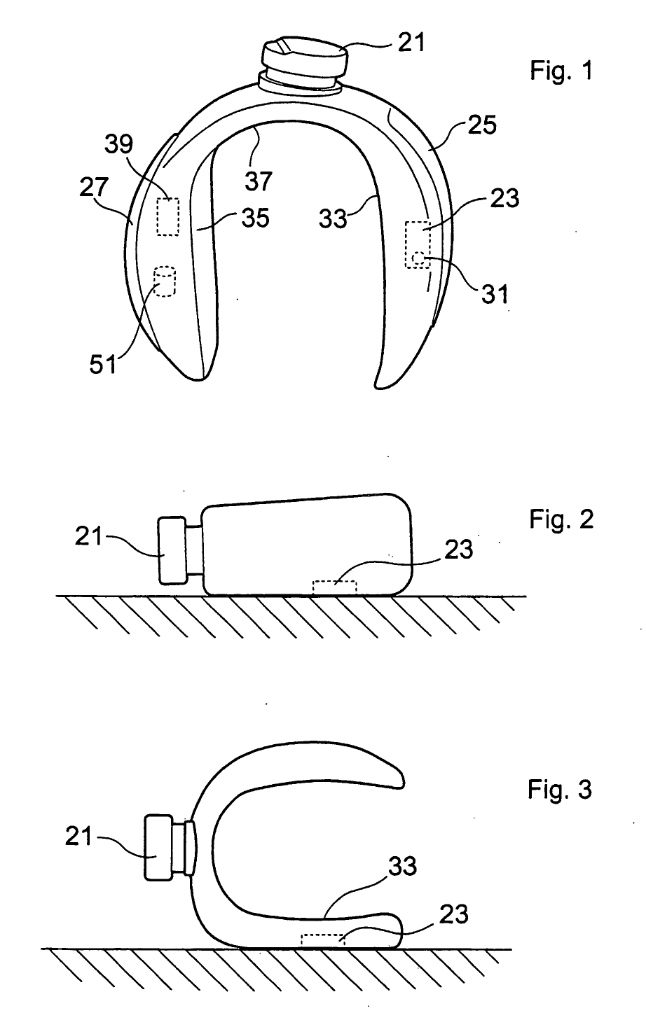

FIG. 1 thus shows schematically a side perspective view of an embodiment of the device according to the invention. The device is arranged for inputting control signals to a peripheral unit 19 (see FIG. 15). The peripheral unit 19 may for example constitute a computer. The device comprises a first input member 21. The first input member 21 is arranged such that the manipulation of this first input member 21 causes the device to produce control signals suited to be transmitted to the peripheral unit 19 such that the manipulation of the first input member 21 fulfils the same function as the manipulation of a joystick or as the movement of a standard computer mouse. The first input member 21 may thus be called a pointer member. The first input member 21 shown in FIG. 1 is constructed in the same manner as a small joystick (but with a more comfortable upper surface which is suited to be touched by a finger). This means that the first input member 21 may be tilted in different directions in order to move for example a graphical entity on a computer screen in all different directions across the screen. It can be mentioned that the first input member 21 may of course also be used to move other entities, such as a remote-controlled robot arm. The device according to the invention may be used in many other applications, for example in connection with computer or television games, for controlling multiple function boxes or media terminals, in connection with CAD-applications or any other application with includes the interaction with a computer.

The device comprises a second input member 25 and a third input member 27. These input members 25, 27 may for example be arranged to function as the click-buttons on a computer mouse. The device may of course comprise further input members. For example, the device may include scroll-wheels or other input members for fulfilling a scroll-function. It is also possible that the device comprises a plurality of further input members for inputting alphanumerical characters to a peripheral unit. The device may of course also comprise other kinds of input members, for example different kinds of toggle switches, stepless switches, rotary switches etc. The device may also comprise more than one pointer device which may be manipulated, for example two pointer devices which can be manipulated simultaneously. The device may thus comprise different control members known for example in connection with game controls.

The device is designed such that it in a first working position can be worn on a first hand of a user such that the device is retained in a predetermined position on said first hand. The device may be constructed in different manners in order to fulfil this function. For example, the device may include Velcro-bands or other means for holding the device onto a hand. The first input member 21 is preferably positioned on the device such that when the device is retained in said predetermined position on said first hand, the first input member 21 is not positioned on any of the fingers but within an area on said first hand that is substantially either on the back of the hand including the lower portion of the thumb and extending to and including the outer boundary of the thumb or in the region between the thumb and the part of the side of the first hand located closest to the thumb, such that the first input member 21 is easily manipulated with one or more fingers of the second hand of the user.

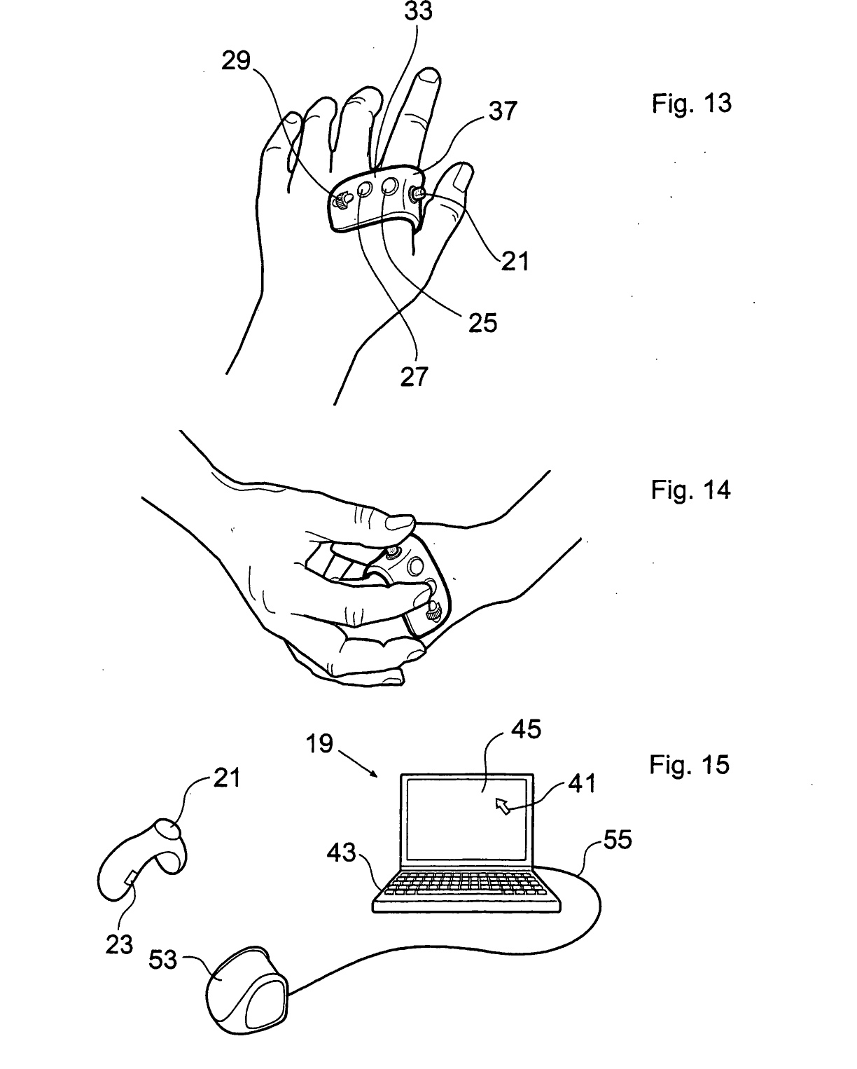

According to the shown embodiment, the device is designed such that it comprises a U-shaped portion, which thus has a first straight part 33, a second straight part 35 and a bent part 37 connecting the first part 33 and the second part 35. The device is designed such that it in said first working position can be worn on a hand such that the first part 33 is located essentially on the back of the hand, the second part 35 is located essentially on the palm side of the hand while the bent part 37 extends from the back of the hand to the palm side of the hand in the region between the thumb and the index finger of the first hand. The device is thus suitably arranged such it can be worn on a normal sized hand in this manner. The device may be shaped after the shape of a hand or adapted to the shape of a hand such that the device is designed to be retained in a predetermined position on a hand. The device may also comprise padding which makes it more comfortable to use. FIG. 13 shows schematically a device worn on a hand in this manner. The device in FIG. 13 comprises a first input member 21 in the shape of a small joystick. The device also comprises a second input member 25 and a third input member 27. Furthermore, the device according to this embodiment comprises a scroll-wheel 29.

The first input member 21 is preferably arranged on said first straight part 33 or on said bent part 37. It should be mentioned that the device may of course extend further than is shown in FIG. 13. The U-shaped portion may thus constitute only a part of the device. According to such an embodiment, it is also possible that the first input member 21 is positioned on another part of the device than above the U-shaped portion which holds the device onto the hand. Preferably, the first input member 21 is positioned such that it can be easily and comfortably manipulated with one of more fingers of the second hand of the user. An example of how the device may be used is shown in FIG. 14. A user may thus manipulate the first input member 21 with one finger at the same time as it is possible to manipulate the other input members 25, 27, 29 with other fingers of the second hand. According to an alternative embodiment, it is also possible that the first input member 21 is positioned such that it can be manipulated with a finger of the same hand as on which the device is worn.

With reference again to FIG. 1, the device also comprises a sensing member 23, which, when the device is arranged in a second working position (to be described later), senses the movement of the device across a surface and in response hereto causes the device to produce control signals suited to be transmitted to the peripheral unit 19, such that the movement of the device across the surface fulfils the same function as the movement of a standard computer mouse.

The first input member 21 and the sensing member 23 may be the same or different members. In FIG. 1 these members are different members. In FIG. 1, the sensing member 23 is shown as a window. In this embodiment the sensing member 23 constitutes an optical sensing member arranged to optically sense the relative movement between an object, for example a surface, and the device and to produce said control signals in response to the sensed relative movement.

According to the shown embodiment, the device also comprises means 31 for sensing whether the device is arranged in the first or the second working position. The means 31 may in this case form part of the sensing member 23. The device may thus optically sense whether the device is arranged in said first or second working position. It should however be noted, that the means 31 for sensing the working position may be separate from the first input member 21 and the sensing member 23. The means 31 may for example be formed to mechanically sense whether the device is positioned on a surface. The device may also be arranged to sense whether it is worn on a hand, i.e. whether it is in said first working position. In particular when the device comprises a U-shaped portion, the device may include means which detects whether a part of a hand is positioned in the U formed by the U-shaped portion. Such means may for example be arranged to optically detect the presence of a hand. Alternatively, the presence of a hand may be detected by inductive, capacitive or any other means.

FIG. 1 also shows in hatched lines that the device may comprise a battery 51. The battery 51 is preferably rechargeable. Also shown in hatched lines is a transmitter unit 39. The transmitter unit 39 is arranged for transmitting control signals to the peripheral unit 19 in a wireless manner. According to this embodiment, it is not necessary to connect the device to the peripheral unit 19 by means of a cable. The device of course also comprises necessary control circuits (not shown) in order to connect the different input and sensing members and the transmitter unit and the battery to each other and in order to control the generation of control signals in response to the manipulation of the device. The casing of the device may for example be formed in a plastics material. However, any other suitable material may also be used.

FIG. 2 shows schematically the device in the second working position. The device is preferably designed such that it is able to rest in a stable predefined manner on a substantially flat horizontal surface. The sensing member 23 is arranged such when the device is moved across the surface, while maintaining the stable position, the sensing member 23 senses the movement of the device across the surface. FIG. 2 shows schematically the embodiment of FIG. 1 where the device rests on such a horizontal surface. If the device of FIG. 2 is observed from above, the U-shaped portion forms substantially a U on the surface.

FIG. 3 shows an alternative position of the sensing member 23. According to this embodiment, the device is designed to rest in a stable manner on a horizontal surface such that the sensing member 23 is directed downwards when the U-shaped portion forms a U (which is lying down) when observed from the side. This could be expressed in other words such that the U-shaped portion forms substantially a U on a plane which is perpendicular to the horizontal surface if the U-shaped portion is projected in a horizontal direction onto said plane. In the embodiment of FIG. 3, the device can thus rest in a stable manner on the side below the straight part 33. Of course, according to this embodiment, the second input member 25 can not be positioned as shown in FIG. 1.

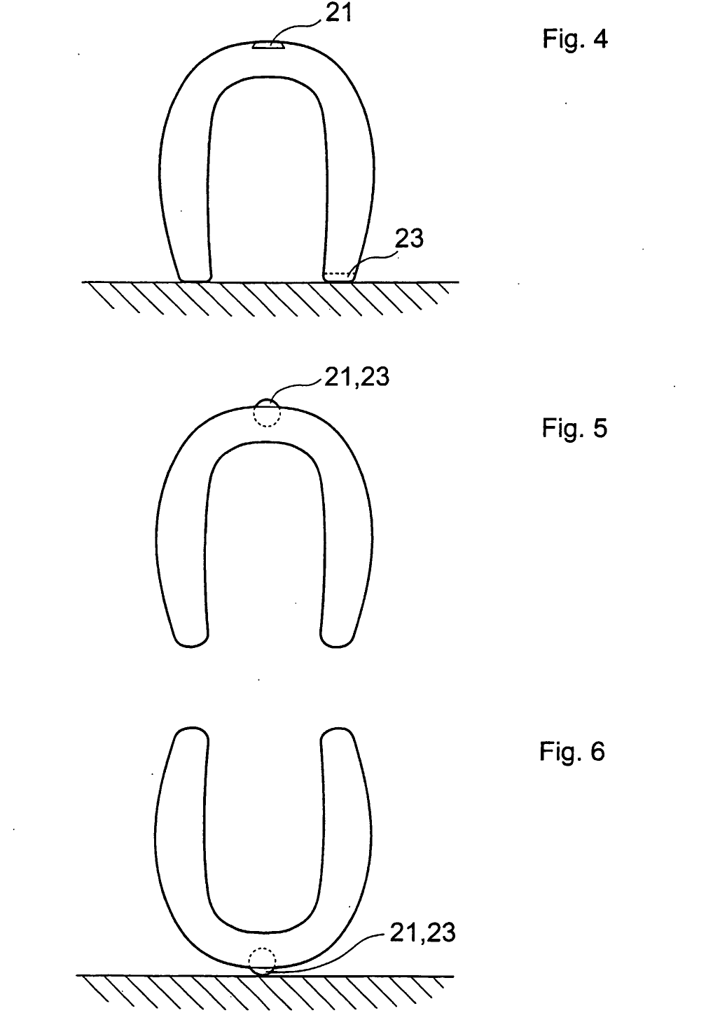

FIG. 4 shows schematically another embodiment of the device according to the invention in the second working position. According to this embodiment, the first input member 21 comprises an optical sensing member. Also the sensing member 23 comprises an optical sensing member. According to this embodiment, the sensing member 23 is positioned at the end of one of the essentially straight parts of the U-shaped portion. When the device is arranged in the second working position, the device thus according to this embodiment forms a U, which is upside down, when viewed from the side. The device may be formed such that it rests by itself in the second working position. Alternatively, the device may be designed to be supported by a hand in order to hold it in the second working position. In the embodiments shown so far, the sensing member 23 is designed for optically sensing the movement across a surface. However, the sensing member 23 may be formed in any other manner known to a person skilled in the art. For example, the sensing member 23 may comprise a ball of the kind known in a standard computer mouse. Also the first input member 21 may be formed in different manners, for example in the form of a ball or in the form of a touch sensitive surface.

The device is arranged to operate in a first or second operation mode. The first operation mode is intended for the situation when the device is in the first working position and the second operation mode is intended for the situation when the device is in the second working position (i.e. positioned on a surface). In the first working position, the first input member 21 is activated to control a cursor or other entity of the peripheral unit 19. In the second operation mode, the sensing member 23 is activated instead. As has been mentioned above, the device may comprise means 31 for automatically sensing whether the device is in the first of second working position. The device may thus be arranged to automatically set the device in the first or second operation mode in response to the sensing by the means 31. Alternatively, the device may be arranged such that a user by manipulating an input member 25, 27 may select whether the device is in the first or second operation mode. For this purpose, the device may comprise a separate input member for selecting the mode. Alternatively, one of the input members 25, 27 (or both input members 25, 27) may be manipulated in a predetermined manner in order to set the mode. For example, the input member 25 could be pressed a certain number of times in order to select the mode.

In the embodiments described so far, the first input member 21 is separate from the sensing member 23. It will now be described different embodiments where the first input member 21 and the sensing member 23 are one and the same member. It should be noted, that like the FIGS. 2-4, the FIGS. 5-12 only show the device very schematically and do not show the different further input members etc. which have been described above. However, the device according to the embodiments shown in FIGS. 5-12 may comprise similar parts to those described above.

FIG. 5 shows schematically an embodiment of the device where the first input member 21 is identical to the sensing member 23. This member 21, 23 comprises according to this embodiment a ball. The ball thus functions as a track-ball when the device is used in the first working position. The ball 21, 23 is positioned such that when the device is used in the second working position, the device is held with the hands against a surface in a position as shown substantially in FIG. 6. According to this embodiment, the device does normally not by itself rest in a stable manner on the horizontal surface.

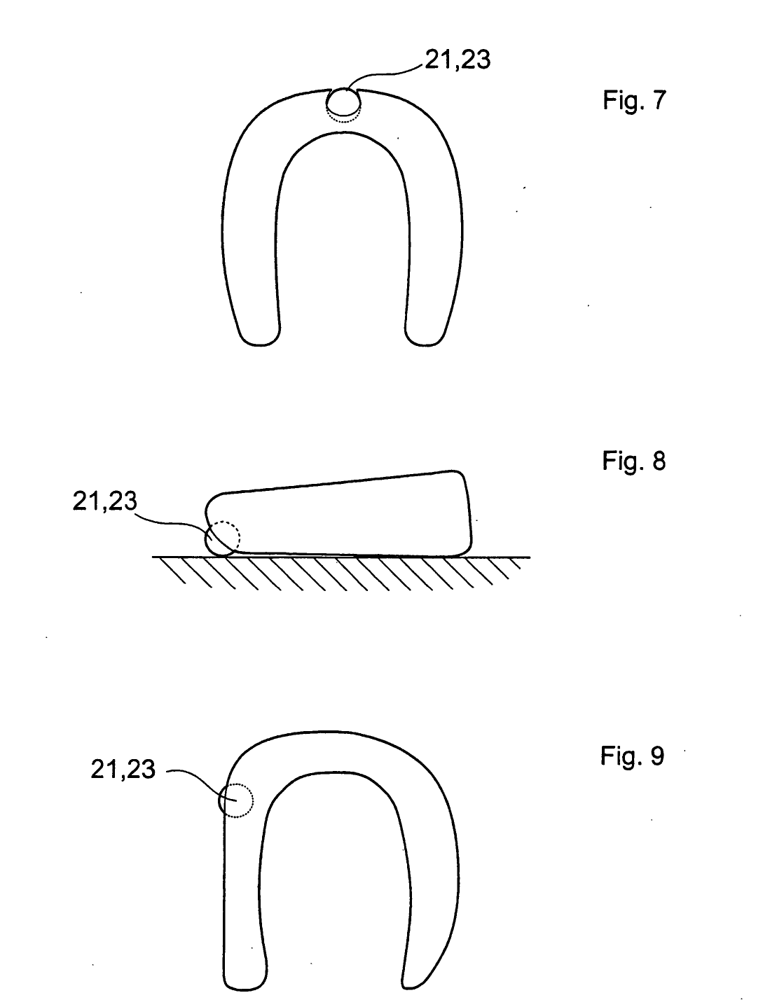

FIG. 7 shows a slightly different position of the member 21, 23 which also here comprises a ball. FIG. 8 shows the device according to FIG. 7 when it rests on a surface. As can be seen in FIG. 8, the ball 21, 23 is arranged such that it may function as the ball on a computer mouse when the device rests in a stable position on a surface. In this case the device rests such that the U-shaped portion can be seen as substantially a U when the device is viewed from above and when it rests on a horizontal surface.

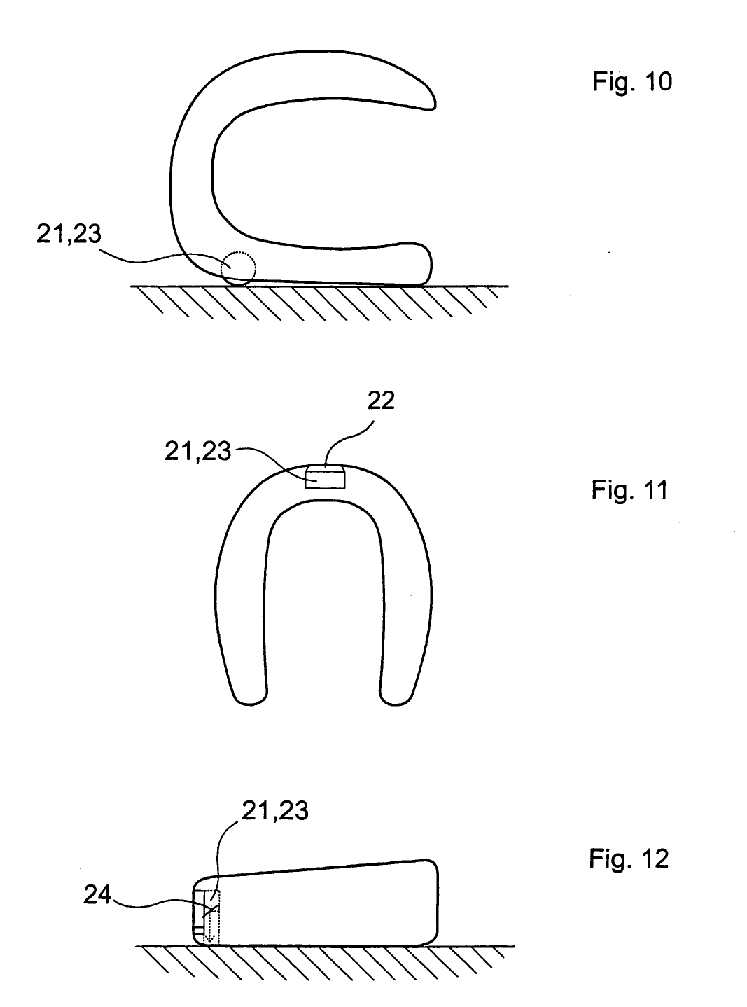

FIGS. 9 and 10 show another embodiment where the first input member 21 is identical with the sensing member 23. Also in this case this member 21, 23 comprises a ball. The ball is positioned slightly on the side of the device as seen in FIG. 9. This means that the device is designed to rest in a stable position as shown in FIG. 10 in the second working position. The U-shaped portion is here seen as substantially a U (which is lying down) when the device is observed from the side as seen in FIG. 10. In this stable working position the ball 21, 23 touches the surface and the device may thus be moved across the surface in a similar manner to a standard computer mouse.

FIGS. 11 and 12 show schematically another embodiment where the first input member 21 is identical with the sensing member 23. In this case the member 21, 23 comprises an optical sensing member. In FIG. 11 the optical sensing member 21, 23 is directed upwards such that a finger can be moved across the member 21, 23 in order to for example move a cursor or other entity. The member 21, 23 preferably comprises a window on a top surface 22 over which the finger may be moved. FIG. 12 shows the device of FIG. 11 when it rests in a stable position on a horizontal surface. The optical sensing member is arranged such that it can sense the movement across the surface when the device is in the position shown in FIG. 12. In FIG. 11 the device preferably senses a finger positioned on top 22 of the device shown in FIG. 11. The optical sensing member is therefore arranged such that it can sense both a finger on the top 22 (in the first working position) and sense sideways when the device is positioned as in FIG. 12 (which means sensed in a downward direction in FIG. 12). This can be obtained for example in that the optical sensing member comprises mirror means 24 which can be moved to the position shown in FIG. 12 when the device is used on a surface, such that camera means may detect the reflected beam from the surface.

In the embodiments shown in FIG. 5-12 the device is preferably arranged to generate a first and second mode control signal indicating, respectively, a first and second operation mode. The first operation mode is intended for the situation when the device is in said first working position. In the first operation mode the manipulation of the first input member 21, 23 in a first direction relative to the device corresponds to the movement of a cursor or other entity 41 of the peripheral unit 19 in a first corresponding direction. In the second operation mode, the manipulation of the first input member 21, 23 in the first direction relative to the device corresponds to the movement of a cursor or other entity 41 of the peripheral unit 19 in a second direction which is different from the first corresponding direction. Thereby the device can be optimised for being comfortable and easy to use in said first and second working position. The device is preferably arranged to automatically sense whether it is arranged in the first or second working position and to generate control signals in response to the sensing. Alternatively, or additionally, the device may be arranged such that the user by manipulating an input member on the device can select whether the device is in the first or second operation mode. It should be noted that the mode control is optional. Instead it may be possible that the device, when it is in the second working position, may be rotated such that the movement of a cursor or other entity corresponds to what is normal for a standard computer mouse.

FIG. 15 shows schematically a combination according to the invention. The combination comprises a device as has been described above and a peripheral unit 19. According to this embodiment, the peripheral unit 19 includes a computer 43 and a screen 45. The combination is set up or programmed such that the manipulation of the first input member 21 or the movement of the device across the surface causes a cursor, pointer arrow or other graphical entity 41 to move across the screen 45. According to one embodiment, the device may also be arranged with contact surfaces (not shown) which can co-operate with corresponding contact surfaces (not shown) on a docking member 53. The docking member 53 is preferably shaped such that the device can dock with the docking member 53 and thus be connected to the docking member 53 via the contact surfaces. The docking member 53 may for example be arranged to be used when a battery in the device according to the invention is being recharged. The battery in the device may be recharged through the docking member 53. The docking member 53 may be connected to the computer device as shown with the cable 55. This makes it possible to use the device also when it is being recharged. Furthermore, it is also possible that the docking member 53 is arranged to comprise its own mouse function. This means that when the docking member 53 is moved across the surface, a cursor or other entity 41 of the computer screen 45 may be moved.

The function of the device according to the invention may be implemented in manners known to the person skilled in the art in connection with known pointer devices. For example it is well known how to construct a standard computer mouse with a ball which senses the movement over a surface. An optical mouse is known for example from the above-mentioned U.S. Pat. No. B1-6,281,882. How to optically sense the movement of a finger is known for example from the above-mentioned U.S. Pat. No. 6,057,540.

It should also be mentioned that the first input member 21 and the sensing member 23 may be positioned in different manners than those described above. Furthermore, the device may comprise several more input members. Possible click-buttons 25, 27 are preferably arranged such that they can be used both in the first working position and in the second working position. Alternatively, it is possible to have several different click-buttons: two click-buttons for the first working position and two other click-buttons for the second working position. Preferably said first input member 21 is positioned on the device such that when the device is retained in said predetermined position on the first hand, the first input member is located either on the back of the hand or in the area between the thumb and the index finger of the hand. It is also possible that the first input member 21 is positioned inside the hand. Preferably, the first input member is not positioned on the device such that it is positioned on a finger.

It may also be mentioned that when it above is said that in the second working position the device is arranged to rest in a stable predefined manner, this means that the device will have at least three support points such it rests in a stable manner on the surface and such that a small force from the side onto the device does not lead to the fact that the device tips over.

The invention is not limited to the described embodiments but may be varied and modified within the scope of the following claims.

What is claimed is:

1-31. (canceled)

32. A device for inputting control signals to a peripheral unit the device being designed to, in a first working position, be worn on a first hand of a user of the device such that the device is retainable in at least one predetermined position on said first hand,
wherein the device comprises at least a first input member arranged such that the manipulation of this first input member causes the device to produce control signals suited to be transmitted to said peripheral unit such that the manipulation of said first input member fulfils the same function as the manipulation of a joystick or as the movement of a standard computer mouse,
wherein said first input member is arranged on said device such that when the device is retained in said predetermined position on said first hand, the first input member is easily manipulated by one or more fingers of said user,
wherein the device is designed such that, it is, in a second working position, arrangable on a surface and movable across this surface and comprises a sensing member which senses the movement of said device across said surface and in response hereto causes the device to produce control signals suited to be transmitted to said peripheral unit such that the movement of said device across said surface fulfils the same function as the movement of a standard computer mouse.

33. A device according to claim 32, wherein said first input member and said sensing member are one and the same member.

34. A device according to claim 33, wherein said first input member comprises a ball and wherein the device is arranged to sense the rotation of this ball and to produce said control signals in response to the rotation of this ball.

35. A device according to claim 33, wherein said first input member comprises an optical sensing member and wherein the device is arranged to optically sense the relative movement between an object, such as a finger or a surface, and said device and to produce said control signals in response to the sensed relative movement.

36. A device according to claim 33, wherein the device in addition to said first input member comprises at least a second input member.

37. A device according to claim 33, wherein said device is arranged to generate a first and second mode control signal indicating, respectively, a first and second operation mode, wherein the first operation mode is intended for the situation when the device is in said first working position, wherein in said first operation mode the manipulation of said first input member in a first direction relative to the device corresponds to the movement of a cursor or other entity of said peripheral unit in a first corresponding direction, and wherein the second operation mode is intended for the situation when the device is in said second working position, wherein in said second operation mode the manipulation of said first input member in said first direction relative to the device corresponds to the movement of a cursor or other entity (41) of said peripheral unit in a second direction which is different from said first corresponding direction.

38. A device according to claim 37, wherein the device comprises means for sensing whether the device is arranged in said first or second working position and wherein the device is arranged to automatically generate said first or second mode control signals in response to said sensing.

39. A device according to claim 37, wherein the device is arranged such that a user by manipulating an input member on said device can select whether the device is in said first or second operation mode.

40. A device according to claim 33, comprising a U-shaped portion, which thus has first and second at least relatively straight parts and a bent part connecting said first and second parts, wherein said device is designed to, in said first working position when the device is retained in said predetermined position on said first hand, be worn on said first hand such that the first part is located essentially on the back of the hand, the second part is located essentially on the palm side of the hand while the bent part extends from the back of the hand to the palm side of the hand in the region between the thumb and the index finger of said first hand.

41. A device according to claim 40, wherein said first input member is positioned on said first part or on said bent part.

42. A device according to claim 33, wherein the device is designed such that when it is in said second working position, it is able to rest in a stable predefined manner on a substantially flat horizontal surface and wherein said sensing member is arranged such that when the device is moved across said surface, while maintaining said stable predefined manner, said sensing member senses the movement of said device across said surface.

43. A device according to claim 42, wherein said device is designed such that when the device is arranged in said second working position on a horizontal surface, the U-shaped portion forms substantially a U on said surface if the U-shaped portion is projected down onto said surface in a vertical direction.

44. A device according to claim 42, wherein said device is designed such that when the device is arranged in said second working position on a horizontal surface, the U-shaped portion forms substantially a U on a plane which is perpendicular to said surface if the U-shaped portion is projected in a horizontal direction onto said plane.

45. A device according to any claim 33, wherein said first input member is positioned on said device such that when the device is arranged in said first working position and retained in said predetermined position on said first hand, the first input member is positioned not on any of the fingers but within an area on said first hand that is substantially either on the back of the hand including the lower portion of the thumb and extending to and including the outer boundary of the thumb or in the region between the thumb and the part of the side of the hand located closest to the thumb, such that the first input member is easily manipulated with one or more fingers of the second hand of the user.

46. A device according to claim 33, comprising a transmitter unit (arranged for transmitting said control signals to the peripheral unit in a wireless manner.

47. A device according to claim 32, wherein said first input member and said sensing member are different members.

48. A device according to claim 47, wherein one or both of said first input member and said sensing member comprises a ball and wherein the device is arranged to sense the rotation of this ball and to produce said control signals in response to the rotation of this ball.

49. A device according to claim 47, wherein one or both of said first input member and said sensing member comprises an optical sensing member and wherein the device is arranged to optically sense the relative movement between an object, such as a finger or a surface, and said device and to produce said control signals in response to the sensed relative movement.

50. A device according to claim 47, wherein the device in addition to said first input member and said sensing member (comprises at least a second input member.

51. A device according to claim 47, comprising a U-shaped portion, which thus has first and second at least relatively straight parts and a bent part connecting said first and second parts, wherein said device is designed to, in said first working position when the device is retained in said predetermined position on said first hand, be worn on said first hand such that the first part is located essentially on the back of the hand, the second part is located essentially on the palm side of the hand while the bent part extends from the back of the hand to the palm side of the hand in the region between the thumb and the index finger of said first hand.

52. A device according to claim 51, wherein said first input member is positioned on said first part or on said bent part.

53. A device according to claim 47, wherein the device is designed such that when it is in said second working position, it is able to rest in a stable predefined manner on a substantially flat horizontal surface and wherein said sensing member is arranged such that when the device is moved across said surface, while maintaining said stable predefined manner, said sensing member senses the movement of said device across said surface.

54. A device according to claim 53, wherein said device is designed such that when the device is arranged in said second working position on a horizontal surface, the U-shaped portion forms substantially a U on said surface if the U-shaped portion is projected down onto said surface in a vertical direction.

55. A device according to claim 53, wherein said device is designed such that when the device is arranged in said second working position on a horizontal surface, the U-shaped portion forms substantially a U on a plane which is perpendicular to said surface if the U-shaped portion is projected in a horizontal direction onto said plane.

56. A device according to claim 47, wherein said first input member (is positioned on said device such that when the device is arranged in said first working position and retained in said predetermined position on said first hand, the first input member is positioned not on any of the fingers but within an area on said first hand that is substantially either on the back of the hand including the lower portion of the thumb and extending to and including the outer boundary of the thumb or in the region between the thumb and the part of the side of the hand located closest to the thumb, such that the first input member is easily manipulated with one or more fingers of the second hand of the user.

57. A device according to claim 47, comprising a transmitter unit (arranged for transmitting said control signals to the peripheral unit in a wireless manner.

58. A device according to claim 47, wherein said device is arranged to operate in a first or second operation mode, wherein the first operation mode is intended for the situation when the device is in said first working position and wherein said first input member is activated to control a cursor or other entity of said peripheral unit, and wherein the second operation mode is intended for the situation when the device is in said second working position and wherein said sensing member is activated to control a cursor or other entity of said peripheral unit.

59. A device according to claim 58, wherein the device comprises means for sensing whether the device is arranged in said first or second working position and wherein the device is arranged to automatically set the device in said first or second operation mode in response to said sensing.

60. A device according to claim 58, wherein the device is arranged such that a user by manipulating an input member on said device can select whether the device is in said first or second operation mode.

61. In combination a device according to claim 32 and a peripheral unit, wherein said combination is set up or programmed such that the manipulation of said first input member or the movement of said device across said surface causes the peripheral unit to control at least one entity of the peripheral unit.

62. A combination according to claim 61, wherein said peripheral unit includes a computer (and a screen and wherein said combination is set up or programmed such that the manipulation of said first input member or the movement of said device across said surface causes a cursor or other graphical entity to move across said screen.
